(19) United States
(12) Patent Application Publication
(10) Pub. No.: US 2014/0206435 A1
(43) Pub. Date: Jul. 24, 2014

(54) Methods for Enhancing Conditional Wagering

(71) Applicant: Scientific Games International, Inc., Newark, DE (US)

(72) Inventors: John Toohey, Boca Raton, FL (US); Kenneth Earl Irwin, Jr., Dawsonville, GA (US)

(73) Assignee: Scientific Games International, Inc., Newark, DE (US)

(21) Appl. No.: 14/159,507

(22) Filed: Jan. 21, 2014

Related U.S. Application Data
(60) Provisional application No. 61/754,773, filed on Jan. 21, 2013.

(51) Int. Cl. G07F 17/32

(52) U.S. Cl. CPC G07F 17/3244
USPC 463/25

(57) ABSTRACT

A computer-implemented method is provided for conducting a parlay wagering game wherein players place a parlay wager on a plurality of linked wagering events. The odds of winning and respective parlay payouts are computed for the parlay wagering game and presented to the players. Wagers are then collected from the players for the particular parlay game they select prior to the first wagering event. If the player is a winner in the first wagering event, an exit payout is calculated and presented to the player that is less than the original parlay payout. The player is presented with the option to accept the exit payout and cash out of the parlay wagering game or to continue with play of the original parlay wager.

### RELATED APPLICATION

The present application claims priority to U.S. Provisional Application Ser. No. 61/754,773, filed Jan. 21, 2013, the entire disclosure of which is incorporated herein by reference in its entirety for all purposes.

### FIELD OF THE INVENTION

The subject matter of the present application relates in general to control mechanisms for parlay betting, and more particularly to a control mechanism setup wherein the consumer has the option to exit from a series of iterative parlay wagers at any time during the process, thereby collecting any reduced winnings earned up to that point in the process.

### BACKGROUND

In designing games of chance, particular attention must be paid to mathematically relating sales of products to frequency and magnitude of prizes such that the sum of all prizes plus expenses for producing, distributing, and selling the games of chance does not exceed the income from sales. In general, higher paybacks to players, better odds of winning prizes, and the desirability of prizes offered play a major role in the sales of games of chance.

For example, it is widely known that the law in certain jurisdictions (e.g., Nevada, USA) mandates that the minimum average payout or prize fund for a casino slot machine can be no less than 75%, yet casinos may have their slot machines set for average payouts of between 90% to 95%. The reason for the 15% to 20% higher payout than required by law is due to casinos realizing higher revenue despite the higher payout because of a massive increases in play volume. Thus, the seemingly contradictory goals of higher revenue for the casino can be realized with higher payouts to the consumer with the apparent optimum payout point for casino revenue ranging between 90% and 95%. This is only possible because of the relatively low costs of placing and operating slot machines, with 10% to 5% remainder of sales being more than sufficient to cover the cost of operation as well as ensure a profit.

In addition to prizes, entertainment is delivered to players as a motivation for purchasing gaming products. In optimizing value delivered to the consumer as a stimulus for more sales, there may exist another opportunity to enhance perceived value on games of chance beyond prize paybacks. The present invention provides just such an opportunity.

### SUMMARY OF THE INVENTION

Objects and advantages of the invention will be set forth in detail in the following description, or may be obvious from the description, or may be learned through practice of the invention.

Described are mechanisms, systems, and methodologies that allow a consumer to engage in parlay wagering of separate events with the option of exiting at any time after the initial iteration garnering any accrued winnings at a reduced and unpredictable value. These same mechanisms, systems, and methodologies ensure that the consumer's accumulative winnings will always be less than the Expected Value (EV) for the entire parlay wager. Each early exit offer can be randomized by a limited amount using a game theory matrix to ensure that any future exit offer from the parlay wager would remain unpredictable to the consumer, thereby increasing suspense for the offer at hand.

The increased entertainment value is derived from the suspense incurred by parlay betting extended over a series of separate games or drawings where the prize value increases with each conditional wager. When this increase in potential prize value is coupled with the ability of the consumer to cash out at any time during the parlay sequence, the risk/reward analysis conducted by the consumer at each point as whether to “let it ride” or cash out their winnings tends to greatly enhance the suspense and thereby the perceived value of the game.

In accordance with aspects of the invention, a computer-implemented method for conducting a parlay wagering game is provided wherein players place a parlay wager on a plurality of linked wagering events, such as sporting events, racing events, and so forth. The invention is not limited to any particular type of parlay wagering event. The method includes, with a computer system, computing and presenting to the player the odds of winning and parlay payouts for the parlay wagering game. A wager amount is collected from the player for a particular parlay selected for play by the player prior to the first wagering event. If the player is a winner in the first wagering event, an exit payout is calculated and presented to the player that is less than the original parlay payout. The player is then presented with the option to accept the exit payout and cash out of the parlay wagering game or to continue with play of the original parlay wager.

In a particular embodiment, the option to accept the exit payout is offered to the player for only a win in the first wagering event, wherein play or the original parlay wager would continue for all subsequent wins. In an alternate embodiment, the option to accept the exit payout is offered to the player for a win in more than one of the wagering events up to the final wagering event. For example, the option may be extended for each win up to the final wagering event. In this embodiment, the exit payout is separately calculated and presented to the player for each win of one of the wagering events.

In a further embodiment, a randomization factor may be introduced into each calculation of the exit payouts so that the exit payout cannot be pre-determined by the player.

The exit payout may be variously computed. For example, the payout may be computed as a function of a new probability of successfully completing the remainder of the parlay wager, wherein the newly calculated payout is subtracted from the originally offered payout to ensure that the exit payout offered to the player is less than a payout on a wager of a single selection in the parlay.

It should be appreciated that the present methodologies are not limited by any particular betting forum or environment. For example, in one embodiment, the method maybe conducted within a gaming establishment, such as a casino or other betting house, and offered to patrons of the gaming establishment. In an alternate embodiment, the method may be conducted via a wide area communications network and offered to remote players via electronic devices interfaced with the network, for example to qualified players via the Internet.

### BRIEF DESCRIPTION OF THE DRAWINGS

FIG. 1 is a flow chart of a representative example of the control method for calculating the initial parlay betting odds; and,

FIG. 2 is a flow chart of a representative example of the control method for conducting parlay follow-on wagers initiated in FIG. 1.

### DETAILED DESCRIPTION

Reference will now be made to one or more embodiments of the system and methodology of the invention as illustrated in the figures. It should be appreciated that each embodiment is presented by way of explanation of aspects of the invention, and is not meant as a limitation of the invention. For example, features illustrated or described as part of one embodiment may be used with another embodiment to yield still a further embodiment. It is intended that the invention include these and other modifications that come within the scope and spirit of the invention.

As those skilled in the art understand, traditional parlays are popular in that they offer the potential for a big payoff from a small wager. A parlay is a single bet that links together two or more individual wagers and is dependent on all of those wagers winning together. The benefit of the parlay is that there are much higher payoffs than placing each individual bet separately (because the difficulty of hitting the parlay is much higher). If any of the bets in the parlay lose, the entire parlay loses. If any of the plays in the parlay ties (“pushes”), the parlay reverts to a lower number of teams with the odds reducing accordingly. In sporting events, the parlay is a collection of two or more teams that the player places a wager on and each team must win in order for the player to win the bet. If the player places a four team parlay, going 3-1 is no different than going 0-4. All of the teams must win, or at least tie, for the player to win. The following is an example of a traditional Las Vegas Parlay Card, which shows the representative payouts for up to 15 team parlay bet:

| Number | Odds |
|---|---|
| 2 Team Parlay | 13 to 5 |
| 3 Team Parlay | 6 to 1 |
| 4 Team Parlay | 10 to 1 |
| 5 Team Parlay | 20 to 1 |
| 6 Team Parlay | 40 to 1 |
| 7 Team Parlay | 75 to 1 |
| 8 Team Parlay | 150 to 1 |
| 9 Team Parlay | 300 to 1 |
| 10 Team Parlay | 700 to 1 |
| 11 Team Parlay | 1100 to 1 |

There are basic types of parlays, including those wagered against the point spread and those wagered against the money line. The payoffs a bettor will receive should they win are quite different in the two. In parlays involving point spreads, the payoffs are fixed, while money line parlay payoffs are determined by the odds of each team.

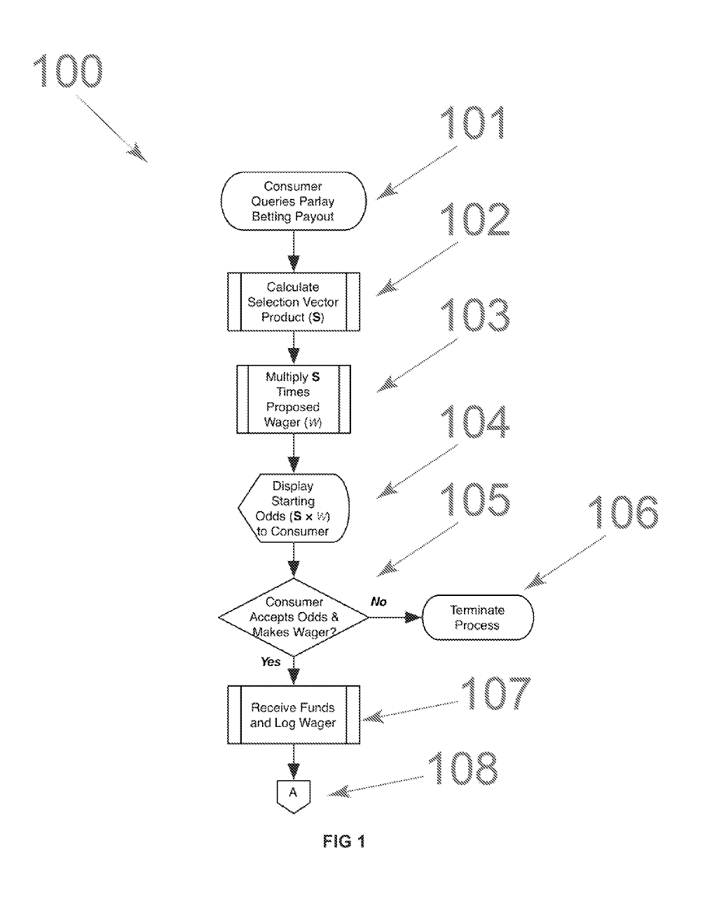

The flow chart 100 of FIG. 1 depicts a representative example of a control method for enabling parlay wagering wherein the consumer has the option to terminate play at any betting juncture in the parlay wager. The control method starts when the consumer queries the parlay wagering system 101 to determine the odds and associated payouts on a conditional series of independent wagers. The system first calculates the product of the selection vector 102, which as its name implies, is a function of the independent wagers proposed by the consumer and associated conditional probabilities. The resultant selection vector product is then multiplied times the proposed wager 103 to determine the proposed payout. This proposed payout is then relayed back to the consumer 104 where the consumer has the option to accept the proposed parlay wager or not at step 105. If the consumer rejects the wager the process is terminated 106. However, if the consumer accepts the proposed wager, the funds are garnered and the wager is logged in a database 107 with the consumer receiving a receipt to await the outcome of the first iteration of the parlay wager.

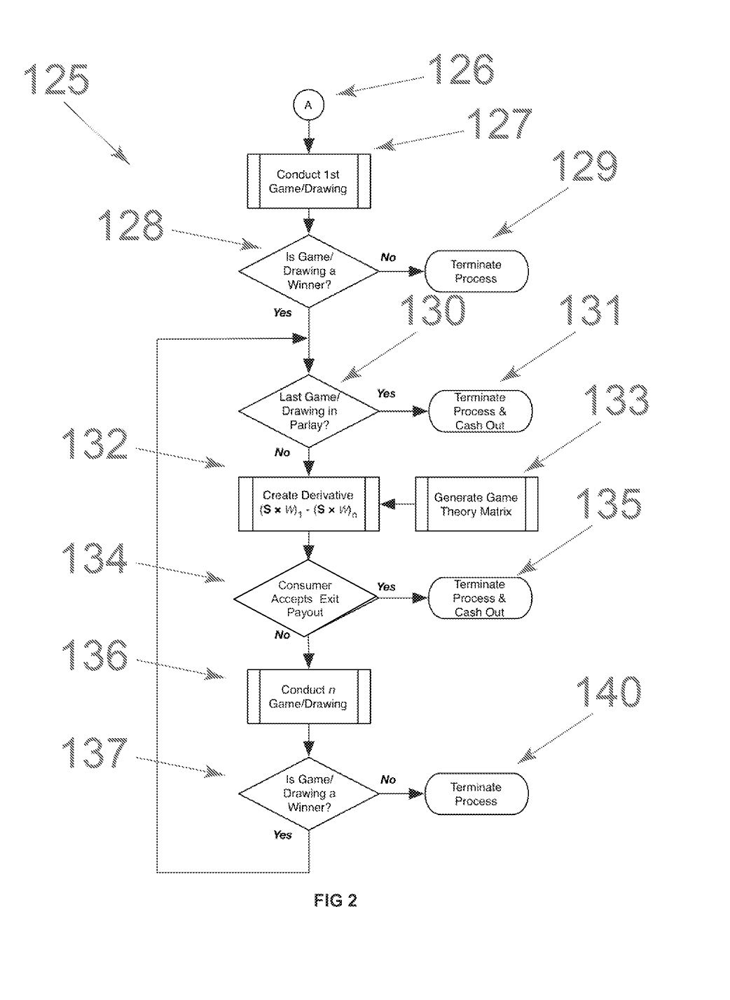

The actual iterations of the parlay wager and associated outcomes are illustrated in FIG. 2, wherein iteration 125 is continued from connector 108 of FIG. 1 to the associated connector 126 of FIG. 2. As shown in FIG. 2, the first wager/drawing of the first bet in the parlay is conducted at 127 with the outcome sent to the consumer. If the consumer losses the first bet the parlay ends and the entire process is terminated at steps 128 and 129. However, if the consumer wins the first bet in the parlay, then a derivative calculation is performed at 132 wherein a payout is calculated that would allow the consumer to exit the parlay with winnings that are less than the original parlay payout. The derivative calculation at step 132 is the new probability of successfully completing the remainder of the parlay wager subtracted from one (metaphysical certainty of winning) with the difference of the new calculated payout subtracted from the originally offered payout to ensure that the new (exit parlay) payout is less than a payout on a single selection. It should be noted that, in the preferred embodiment, the derivative calculation at step 132 ensures against breaking a single parlay bet into multiple exit bets that could have a cumulative payout greater than the original parlay bet(s)—e.g., after two wins, the exit payout offered would be less than double the first bet's payout and perhaps even less than first bet's payout in singularity.

In a particular embodiment, the algorithm that calculates the derivative payout receives input from a game theory matrix 133 to apply randomization to the offering process. Among other things, this randomization process ensures that no patterns appear in the exit parlay payouts. By ensuring that patterns are eliminated from the offering process 133, the consumer's gaming experience is enhanced (as well as his anxiety level) with the unpredictability of the current offer as well as subsequent offers—much like the anxiety levels encountered by players on the popular United States television show ‘Deal or No Deal’.

Returning to the parlay exit offer for the first iteration, the consumer is presented with the calculated payout to exit the parlay and is given the chance to either exit at this point or continue with the original parlay wager at step 134. If the consumer elects to accept the reduced payout and exit, the derivative payout winnings calculated at step 132 are paid out and the process terminates at step 135. However, if the consumer elects to continue with the original parlay wager, the system waits until the next game/drawing is completed at step 136 and it is determined whether the consumer won this iteration of the parlay bet or not at step 137.

In the event the consumer did not win the recent game/drawing the parlay wager is lost and the entire process terminates at step 140. However, in the event the consumer won the most recent iteration of the parlay bet, in one particular embodiment, a new exit offer is calculated using the same derivative algorithm from the game theory matrix in prior step 133, with a new exit offer being extended to the consumer. As shown in FIG. 2 this process continues until the consumer either: (1) accepts an exit offer, (2) the original parlay wager is completed with the consumer winning all iterations 131, or (3) the consumer loses an iteration of the parlay wager that he did not choose to exit before the game/drawing was conducted.

In another embodiment, the option presented to the player to accept the exit parlay payout may be limited to only on, or less than all, of the iteration of the game.

It should be appreciated that the parlay wagering methodologies in accordance with the present invention are applicable to any parlay wagering scheme, and are not limited to, for example, sporting or racing events.

The various control functionalities of the present method embodiments are computer-implemented by any suitably configured computer server, system or network that interfaces with the game provider and player, and with any other party that may participate in the various functionalities, including payout of winnings or presentation of the game to players. For example, the game provider may be a gaming house, casino, or other establishment that utilizes a central host computer system in the conduct of the game in a given jurisdiction. In other embodiments, the game provider may implement a computer system that offer the parlay betting game over a wide area network to any number of players in a given jurisdiction. For example, the parlay betting game may be offered to players via an Internet site maintained by a game provider and accessible by qualified players (e.g., qualified by age and residency) via an Internet enabled electronic device. The game provider's host computer system may also be in communication with a host system maintained by any other party for exchange of data necessary to carry out the present control methods. In a particular embodiment, the game provider host computer may function as the computer system that calculates the initial parlay selection vectors, as well as stores the randomization algorithm and calculates the derivative payouts. The host computer may be in communication with any manner of wired or wireless display via any suitable communications network to display these various values to the players. It should be readily appreciated that the computer-implemented functionalities may be widely configured within the scope and spirit of the invention, and that the invention is not limited to any particular hardware or software configuration.

What is claimed is:

1. A computer-implemented method for conducting a parlay wagering game wherein players place a parlay wager on a plurality of linked wagering events, the method comprising:
with a computer system, computing and presenting to the player the odds of winning and parlay payouts for the parlay wagering game;
collecting a wager amount from the player for a particular parlay selected for play by the player prior to the first wagering event; and
if the player is a winner in the first wagering event, with the computer system, calculating and presenting to the player an exit payout that is less than the original parlay payout, and presenting the option to the player to accept the exit payout and cash out of the parlay wagering game or to continue with play of the original parlay wager.

2. The method as in claim 1, wherein the option to accept the exit payout is offered to the player for only a win in the first wagering event.

3. The method as in claim 1, wherein the option to accept the exit payout is offered to the player for a win in more than one of the wagering events up to the final wagering event.

4. The method as in claim 3, wherein the exit payout is separately calculated and presented to the player for each win of one of the wagering events.

5. The method as in claim 4, further comprising introducing a randomization factor into each calculation of the exit payouts so that the exit payout cannot be pre-determined by the player.

6. The method as in claim 1, further comprising introducing a randomization factor into the calculation of the exit payout so that the exit payout cannot be pre-determined by the player.

7. The method as in claim 1, wherein the exit payout is computed as a function of a new probability of successfully completing the remainder of the parlay wager.

8. The method as in claim 7, wherein the computed exit payout based on the new probability of successfully completing the remainder of the parlay wager is subtracted from is subtracted from the originally offered payout to ensure that the exit payout offered to the player is less than a payout on a wager of a single selection in the parlay.

9. The method as in claim 1, wherein the method is conducted within a gaming establishment and offered to patrons of the gaming establishment.

10. The method as in claim 1, wherein the method is conducted via a wide area communications network and offered to remote players via electronic devices interfaced with the network.

11. The method as in claim 8, wherein the method is offered to qualified players via the Internet.
